(19) United States
(12) Patent Application Publication
(10) Pub. No.: US 2019/0236625 A1
(43) Pub. Date: Aug. 1, 2019

(54) ARRANGEMENT AND METHOD FOR DIGITAL MEDIA MEASUREMENTS INVOLVING USER PANELS

(71) Applicant: Verto Analytics Oy, Helsinki (FI)

(72) Inventors: Hannu VERKASALO, Engelberg (CH); Timo SMURA, Helsinki (FI); Matti AKSELA, Jorvas Kirkkonummi (FI)

(73) Assignee: Verto Analytics Oy, Espoo (FI)

(21) Appl. No.: 16/320,530

(22) PCT Filed: Jul. 27, 2017
(86) PCT No.: PCT/FI2017/050557

§ 371 Date: Jan. 25, 2019

Related U.S. Application Data
(60) Provisional application No. 62/367,159, filed on Jul. 27, 2016.

(51) Int. Cl. G06Q 30/02; H04L 29/08; G06F 16/23; G06F 16/28

(52) U.S. Cl. CPC G06Q 30/0204; H04L 67/22; G06F 16/285; G06F 16/2365; H04L 67/306

(57) ABSTRACT

A method (400) for enhancing data integrity in connection with a digital panel study to be performed by an electronic arrangement preferably comprising one or more servers, wherein the method comprises obtaining data (406) having regard to a plurality of panelists, wherein one or more data points associated with each panelist characterize demographic profile, device ownership, device-level behavioral profile and/or occurrences of events or traffic involving one or more electronic devices associated with the panelist, and where there is more and less complete data associated with different panelists in terms of data points, for a certain panelist of said plurality missing a data point, determining (413), based on the obtained data, a number of other panelists that originally have corresponding data point assigned and are otherwise similar to the certain panelist in terms of a number of other data points according to a selected criterion, preferably requiring similar data point values, and completing the missing data point of the certain panelist, or modeling a virtual panelist having data points assigned similar to the other data points and a further data point, based on data of the corresponding data point of one or more of the determined other panelists. An arrangement for executing the method is presented.

The invention relates generally to digital devices, communications, related applications and services. Particularly, however not exclusively, the present invention pertains to digital user panels and their cultivation through appropriate validation, categorization, completion, and weighting activities to report both comprehensive and reliable metrics based thereon.

### BACKGROUND

Different media measurement, user profiling, Internet panel, mobile panels, digital marketing tools and other analytics solutions require obtaining and analyzing device usage data from a target population and often also from so-called reference groups. The evident goal is to get grasp on the underlying trends, habits, problems and needs, whereupon better suiting, better functioning, more accurate and also larger audience reaching products, services and marketing efforts are easier to design among other potential uses of such data.

User behavior may be generally metered either through dedicated devices or downloadable software meters, or through embedded tags (on (web) sites or applications) or SDKs (software development kit, apps) that collect data on a particular app, for instance. Alternatively, the desired data could be acquired through traditional user survey studies or interviews, which unfortunately typically suffer from respondent subjectivity and inaccuracy.

Meanwhile, the evolution of media and Internet services such as web sites or web-accessible services is faster than ever. Both wired (e.g. desktop computers and smart TVs) and wireless devices (e.g. tablets, phablets, laptops and smartphones) have already changed the way people access and engage with digital services, and as a result, both the business and technological landscapes are encountering constant turbulence.

Further, nature of user behavior is changing quickly due to parallel use of multiple competent devices ranging from the aforesaid smartphones to tablets, and e.g. from laptops to smart TVs. Particularly in a mobile context, the consumers already have a choice from a library of over a million applications, or ‘apps’, available in the app stores, and they can opt to use not only native apps but also e.g. HTML5 (Hypertext Markup Language 5) apps, widgets, web sites, or something in between.

Different electronic terminal devices may even be provided with highly automated, transparent measurement software, which is running in the background automatically meaning no explicit user input or control is necessary. Obtaining data therefrom is not a fundamental problem in a general sense. A limited number of verified device users with fully known personal and device profiles could be carefully recruited in a user panel the constitution of which is rigorously determined and constantly controlled so that the data obtained for measuring and analysis purposes is also fully valid and complete.

However, continuously maintaining such ideal panels in the maelstrom of current technological and media related evolution with large enough reach in terms of geographic, hardware and e.g. demographic coverage turns out impractical and in most cases, impossible.

Instead, measurement data could be somewhat conveniently collected from a greater group of user devices with lessened burden if it is accepted that the data obtained is, or at least may be, fragmented and incomplete. Such imperfect, erroneous or otherwise inapplicable data, notwithstanding its potential large-scale availability, is nevertheless unusable or only very limitedly useful in many analytic purposes including behavioral modeling or media measurements.

There therefore arises a dilemma between the representativeness, completeness and correctness of data in these cases and the actual availability thereof with real-life data mining resources that are practically always e.g. temporally or hardware-wise limited.

### SUMMARY

It is the objective of the invention to at least alleviate one or more drawbacks or challenges related to the prior art measurements.

The objective is achieved by the various embodiments of an arrangement and method in accordance with the present invention.

In one aspect, a method for enhancing data integrity in connection with a digital panel study to be performed by an electronic arrangement preferably comprising one or more servers, comprises
obtaining data having regard to a plurality of panelists, wherein one or more data points associated with each panelist characterize demographic profile, device ownership, device-level behavioral profile and/or occurrences of events or traffic involving one or more electronic devices associated with the panelist, and where there is more and less complete data associated with different panelists in terms of data points,
for a certain panelist of said plurality missing a data point, determining, based on the obtained data, a number of other panelists that originally have corresponding data point assigned and are otherwise similar to the certain panelist in terms of a number of other data points according to selected criterion, preferably requiring similar data point values, and
completing the missing data point of the certain panelist, or modeling a virtual panelist having data points assigned similar to the other data points and a further data point, based on data of the corresponding data point of one or more of the determined other panelists.

The selected criterion or depending on the embodiment, multiple criteria may refer to e.g. predetermined, optionally adaptive, rule(s), which may be defined in the control logic such as control software of the arrangement e.g. prior to the execution of the method or upon beginning the determination procedure of finding mutually similar panelists to complete one or more missing data points among such panelists or the data of virtual panelists derived therefrom.

The criterion/criteria may involve, depending on the embodiment, more generic or specific rules e.g. on numerical differences between data point values to identify mutually similar panelists from the overall or larger group. One feasible criterion of similarity implies equal or close enough (i.e. equal according to tolerable, reduced assessment resolution) data point values.

The criterion/criteria may additionally or alternatively refer to dynamically established or altered criterion/criteria that may evolve even during the determination procedure. The criterion/criteria may be at least partially determined based on data points inspected in the obtained data, for instance. A person skilled in the art may consider keeping at least part of the criterion/criteria consistent throughout the procedures of analyzing and, where necessary, completing the data point(s) of the panelists, to obtain mutually comparable data as output for generating statistically meaningful reports or other deliverables based thereon.

At least one data point may indeed be missing with at least one panelist (a user of electronic device(s) metered) and present, i.e. assigned at least one valid value, with a number of other panelists among said plurality. The method performed by the arrangement, which may further be configured to execute or at least manage at least part of the concerned panel study, may be cleverly harnessed to complete the missing data by the suggested ascription (attribution) mechanism.

In one embodiment, the obtained data having regard to a plurality of panelists is classified into at least two categories. The first category preferably indicates more controlled, or compliant, group of panelists with more complete, or fully complete, data according to selected criterion, and the second category preferably indicates less controlled group of panelists with e.g. less complete or otherwise non-compliant, or ‘invalid’, data. The first category may in some embodiments incorporate, optionally solely, multi-device users as panelists. The second category may in some embodiments incorporate, single-device and/or multi-device users as panelists.

As the data associated with the panelists of the first category is, by definition, substantially or fully complete, the completion activities are primarily or solely targeted to the panelists of the second category. In some embodiments, however, also the data of first category panelists may require completion or correction, whereupon such data/panelists may be subjected to the procedure described herein. Such members of the first category have metering features, such as software, installed at their one or more electronic devices, such as smartphones, tablets, smartwatches or other wearable devices, laptops, and/or desktops, but for one or more reasons these members have been considered as e.g. only semi-compliant, non-compliant or invalid from the standpoint of compliance requirements in a given reporting period. For example, metering activities having regard to a certain registered device associated with a panelist may have not been active or functional for some reason during a selected period of interest, while the functioning of the metering logic in all registered devices (known to be in that panelist's possession) may be a requisite for becoming or staying fully compliant or valid.

In some embodiments, the other panelists are determined solely from the group of more controlled/compliant panelists, i.e. from the first category or sub-group thereof incorporating only compliant panelists. In some other embodiments, the other panelists could be still determined from both first and second category panelists potentially including e.g. semi-compliant, non-compliant or invalid panelists of the first category.

In some embodiments, the data points gathered and/or determined regarding a panelist include profile data points. The profile data points may include e.g. demographic profile, device inventory profile and/or qualitative profile data points (e.g. product consumption, brand awareness). Further, the profile data points may include behavioral profile data points. These data points may describe the behavior of the panelist in a non-event orientation. For example, usage of certain web site or device during a given time period may be described generally without more specifically denoting related sessions, interactions, calls, etc.

In some embodiments, the data points gathered and/or determined regarding a panelist include data indicative of traffic or events involving one or more electronic devices associated with a panelist. The traffic/event data, or data points, may indicate timestamped, recorded occurrences of different events taking place in or relative to a monitored device or data traffic involving the device.

In some embodiments, in connection with the cultivation of data points, preferably at least profile data points, and having regard to a panelist a composite model is applied. In that model known characteristics (preferably 100% certain, e.g. metered or obtained via survey/questionnaire) and most probable characteristics (originally missing but completed based on the similar panelists as reviewed herein) are combined to come up with a panelist with completed or ‘composite’ data. Thus known, e.g. metered or input, data and on the other hand, completed, but originally missing, data that is modeled/estimated based on the data of the other panelists considered similar to the panelist in question are integrated but still preferably remain extricable and distinguishable in the future.

Alternatively, a limited probabilistic model could be applied to cultivate panelist data. A limited number of virtual panelists are established based on the existing data of the panelist in question and data representing the originally missing data point of a corresponding number of other panelists considered most similar to the panelist in question.

As a further option, a so-called unlimited probabilistic model could be considered, although it is computationally exhaustive as being easily understood by a person skilled in the art. In this approach, a virtual panelist may be created for each possible characteristic value having regard to the missing data with an associated probability. A person skilled in the art shall understand that in some embodiments, two or more models could also be creatively combined or used e.g. selectively in parallel.

In some embodiments, the missing data indicative of traffic or other events may be completed for a panelist by determining the other panelists considered similar in terms of electronic device data (e.g. model data such as ‘Samsung SM-G925A Galaxy S6 edge’), device inventory profile data point(s) (which may be more generic by nature than device data, indicative of e.g. ownership of certain number of smartphones or e.g. Samsung smartphone), and/or behavioral profile data point(s). New traffic or other event indicative data (point) is created, i.e. missing data point completed, based on the traffic/event data of the other panelists.

In some embodiments, the panelists are subjected to a validation procedure such as activity validation. Such validation is preferably executed prior to data ascription (attribution) procedures described herein to avoid unnecessary processing; usually there is no reason to complete, process or utilize the data of an invalid panelist.

Alternatively, the validation may be executed after ascription. The related method disclosed in this specification may be executed relative to a predetermined time period such as a reporting period. The validation may be specifically or exclusively targeted to one or more categories of panelists, such as the aforementioned first and/or second category.

For example, the activity validation may utilize a number of criteria that a panelist under scrutiny shall met to be included in the validated group of panelists applied during the data ascription. In the case of e.g. first category panelists, one criterion could require a panelist being active with any electronic device associated with him/her in the profile data during the past, e.g. last predetermined number, e.g. 3, of days. One other, alternative or supplementary, criterion could require a panelist being active with all his/her devices during some other past period, e.g. a longer period such as last 7 days.

In some embodiments, a so-called validity analysis is executed, preferably after ascription, to determine the panelists, including also possible virtual panelists, which are to be included in a reporting dataset. A number of selected criteria may be once again utilized for decision making. For instance, panelists with compound probability below a predetermined threshold may be left out. Panelists with certain attributed (i.e. calculated, not measured), data points such as profile data points considered critical may be left out. Panelists with attributed data points having too low probabilities may be omitted. For example, a profile data point indicative of gender may be such (if e.g. 1% probability has been determined). The validity analysis may be adjusted e.g. on a geographic basis with different aspects emphasized in different areas.

In some embodiments, a structural or enumeration study is utilized. The study may refer to a survey/questionnaire, e.g. offline or online study, executed to outline basic statistical assumptions describing the population researched. For example, desired panel stratification may be determined and/or the data collected or calculated (attributed) calibrated accordingly.

In some embodiments, weighting, or ‘calibration’, is executed to the panelists surviving e.g. the validity analysis. The data associated with the panelists may be calibrated with stratification data obtained from the aforementioned structural study, for instance. A set of calibration variables and categories may be established in order to determine control values. The control values may be utilized in determining calibration weights for the data.

In some embodiments, the completed and potentially weighted and validated data is utilized to produce deliverables such as a number of reports on desired scope, such as panelist and/or general user behavior, multi-screen metrics, device distribution, application or service usage, user demographics, content usage, etc. Such deliverables may be utilized for targeted marketing or technical optimization (application, service, network, terminal, etc.) purposes, for instance.

In one other aspect, an electronic arrangement, preferably comprising a number of at least functionally connected servers, for enhancing data integrity in connection with a digital panel study, incorporates
data management module configured to obtain data having regard to a plurality of panelists, wherein one or more data points associated with each panelist characterize the panelist's demographic profile, device ownership profile, device-level behavioral profile and/or occurrences of events or traffic involving one or more electronic devices associated with the panelist, and where there is more and less complete data associated with different panelists in terms of data points, and
ascription module configured to
   determine, for a certain panelist of said plurality missing a data point, based on the obtained data, a number of other panelists that originally have corresponding data point assigned and are otherwise similar to the certain panelist in terms of a number of other data points according to selected criterion, preferably requiring similar data point values, and to
   complete the missing data point of the certain panelist, or modeling a virtual panelist having data points assigned similar to the other data points and a further data point, based on data of the corresponding data point of one or more of the determined other panelists.

The data management module may physically comprise e.g. a communication interface and/or data repository, such as a number of databases determined in a memory, for storing panel data and/or other data.

Yet, the arrangement may incorporate a user interface (UI) with a number of different elements depending on the embodiment. It may include a local UI such as a display and data input interface such as a touchscreen, keyboard, mouse, etc. It may additionally or alternatively include a remote user or control interface such as a web based interface with necessary hardware such as a (web) server device supplying the data and optionally graphical UI (in the form of a web site or page) to a user via the communication interface. Instead of or in addition to UI, data may be transferred relative to external devices and systems via the communication interface using a desired protocol, which may be a proprietary or more commonly used one.

Still, the arrangement may comprise a reporting module configured to establish a report based on the ascribed data characterizing the data through a number of predetermined, optionally user-determined, metrics, for example. The metrics may be numeric and/or symbolic or graphical, for example. They may involve multi-screen metrics, panelist/user behavior, device distribution, application or service usage, demographic factors etc. as being already mentioned hereinbefore.

The arrangement may further comprise a classification module for categorizing the users into a plurality of groups. For example, panelists considered compliant according to selected criterion may establish a first panel, e.g. a calibration panel such as a so-called ‘smart panel’, whereas another group of panelists may be called a megapanel or ‘boost panel’.

The arrangement may further comprise at least one validation module. The validation tasks execute may include the aforementioned activity validation and/or validity analysis.

The arrangement may further comprise a weighting/calibration module to weight the data of different panelists according to a desired weighting scheme.

The various considerations presented herein concerning the embodiments of the method may be flexibly applied to the embodiments of the arrangement mutatis mutandis, and vice versa, as being appreciated by a person skilled in the art.

The utility of the present invention arises from multiple issues depending on each particular embodiment thereof. A comprehensive large scale user panel of e.g. thousands or hundreds of thousands members in total may be rapidly created by the embodiments of suggested data completion (attribution) mechanism. Data of more rigorously controlled and typically smaller category, panel or group of panelists and data of a larger, less-controlled category, panel or group of panelists may be cleverly combined and selectively cultivated to a larger integral panel, for instance.

First, missing profile data points, such as demographic data points, behavioral data points or device inventory related data points such as ownership/usage of various electronic terminal devices, may be estimated to an existing user (panelist) based on the data of corresponding, preferably truly measured, data points associated with a number of other users considered otherwise similar to the user in question. In some embodiments, instead of completing the existing profile of the user, a number of new virtual users (panelists) may be created based on the metered and estimated data and related probabilities.

Secondly, traffic and other event data may be estimated even for the panelist the device inventory or related traffic/event data of which has not been originally at least completely available.

Therefore, by utilizing both compliant or high quality ‘smart’ panelists the data of which is complete and ‘boost’ panelists the data of which is only partially available, data sets-combining aggregate or integral panel of optionally even higher number of panelists than where originally in either panel together may be formed for reporting purposes on a great variety of topics such as multi-screen usage, demographics, device distribution, application and service usage, etc. By appropriate validation and weighting measures, the results may be cleverly adapted to each target scenario e.g. with geographical target scope.

Additional benefits of the embodiments of the present invention will become clear to a skilled reader based on the detailed description below.

The expression “a number of” may herein refer to any positive integer starting from one (1).

The expression “a plurality of” may refer to any positive integer starting from two (2), respectively.

The expression “panel” may refer herein to a specific, intentionally recruited sample of users of electronic devices (or the devices themselves), i.e. “panelists”, providing data on the desired aspects such as media usage taking place in connection with the devices. In addition or alternatively, the “panel” may in some embodiments refer to basically any other applicable sample of users/devices, i.e. not necessarily the aforementioned particularly set up special panel of dedicated panelists, which is adapted to provide data having regard to the metered aspects. For example, a plurality of end-users of one or more apps downloaded from an app store could constitute at least part of such panel, when the apps have been provided with feasible metering software capable of capturing surveyed data.

Different embodiments of the present invention are disclosed in the attached dependent claims.

### BRIEF REVIEW OF THE DRAWINGS

Few embodiments of the present invention are described in more detail hereinafter with reference to the drawings, in which

FIG. 1 illustrates the embodiments of an arrangement and terminal device in accordance with the present invention in connection with a potential use scenario.

FIG. 2 depicts panelist categorization aspects of the present invention in accordance with an embodiment thereof.

FIG. 3 is a block diagram representing the internals of an embodiment of the arrangement.

FIG. 4 is a flow diagram disclosing an embodiment of a method in accordance with the present invention.

### DETAILED DESCRIPTION

Herein having regard to the description of various embodiments, a panelist without further modifiers/descriptors generally refers to any panelist, regardless of his/her compliance/validity status. A panelist may be described e.g. in terms of profile data points, weight (e.g. proportion factor and/or scale factor) in a given moment of time, whether it is a question of a “virtual panelist” (computed panelist), and/or of probability.

The virtual panelist refers to a panelist that is modeled as a typical panelist in the light of the arrangement, but who has been computationally generated based on the ascription model.

Profile data points refer to characteristics of a panelist defined as profile data points including behavioral profile data points. A profile data point can be described in terms of its value, indication of whether it has been attributed, probability, and/or whether it constitutes a device inventory profile data point.

Behavioral profile data points refer to profile data points that describe a panelist's behavior in a non-event orientation. For instance, they may describe whether a panelist used a given web site, service or device in a given time period, but do not denote the specific sessions, interactions, calls, etc. that the panelist may have generated. Note that behavioral profile data points need to be tied back to a related subject. Furthermore, the points also indicate whether it has been attributed, probability, and indication of panelist device (e.g. device_id) on which the behavior occurred.

Events/traffic refers to timestamped occurrences which are recorded via the meter for metered devices. In general, they can be described in terms of their subject, timestamp (start and end, or occurrence), probability, panelist device on which they occurred, panelist who generated the event, and whether they have been attributed.

Panelist devices are devices which a panelist possesses as determined by their device inventory profile data points. Device inventory profile data points may be obtained using a panelist survey/questionnaire or attributed (ascribed), for instance. They may indicate e.g. general data on the devices of the panelist such as “owns two smartphones” or “owns a tablet or smartphone of certain brand X and optionally of model Y”. A panelist device may either be metered or attributed, and can be described in terms of the device which it represents. A panelist device data may indicate e.g. the more exact model data of a device (e.g. Brand X, Model Y, version Z).

A device generally refers to a physical device e.g. with given branding information and device characteristics.

A processing time period is the time period that is undergoing (batch) processing—e.g. on January 3rd, data may be batch processed for January 2nd 00:00:00—23:59:59 (or as applicable).

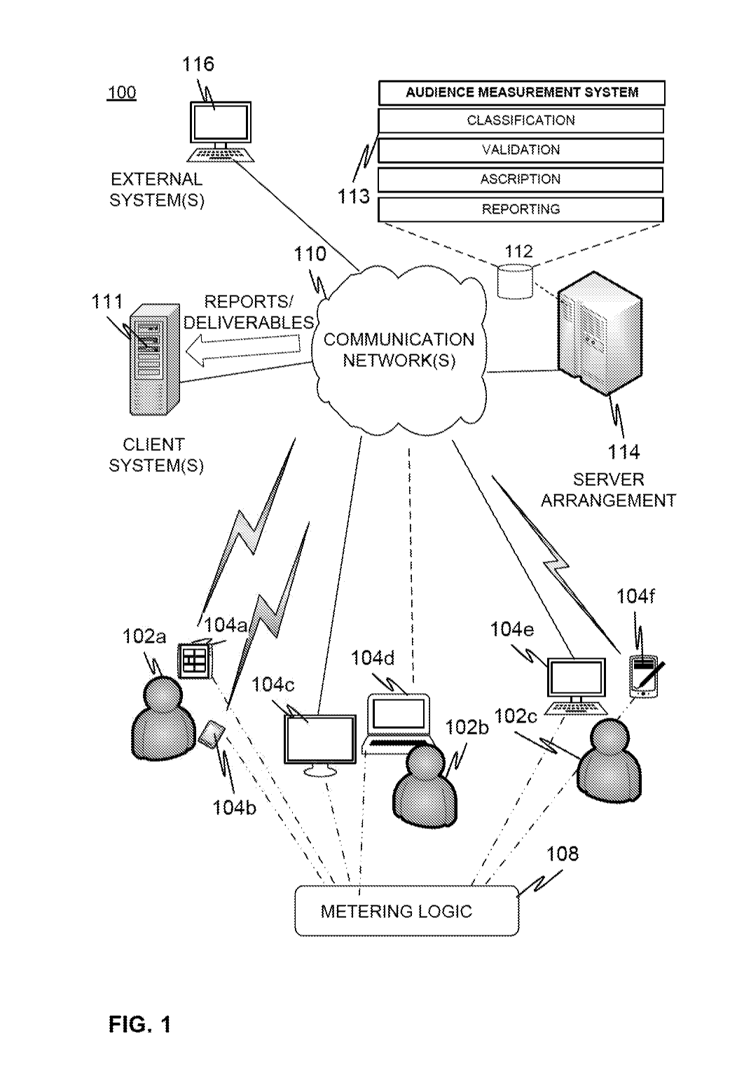

FIG. 1 shows, at 100, one merely exemplary use scenario involving an embodiment of an arrangement 114 in accordance with the present invention and few embodiments 104a, 104b, 104c, 104d, 104e, 104f of terminal devices in accordance with the present invention as well.

Network 110 may refer to one or more functionally connected communication networks such as the Internet, local area networks, wide area networks, cellular networks, etc., which enable terminals 104a, 104b, 104c, 104d, 104e, 104f and server arrangement 114 to communicate with each other.

The arrangement 114 may be implemented by one or more functionally connected electronic devices such as servers and potential supplementary gear such as a number of routers, switches, gateways, and/or other network equipment. In a minimum case, a single device such as a server is capable of executing different embodiments of the method and may thus constitute the arrangement 114 as well.

At least part of the devices of the arrangement 114 may reside in a cloud computing environment and be dynamically allocable therefrom.

The terminals 104a, 104b, 104c, 104d, 104e, 104f may refer to mobile terminals 104a, 104b, 104f such as tablets, phablets, smartphones, cell phones, laptop computers 104d or desktop computers 104c, 104e for instance, but are not limited thereto. The users (panelists) 102a, 102b, 102c may carry mobile devices 104a, 104b, 104d, 104f along while heavier or bulkier devices 104c, 104e often remain rather static if are not basically fixedly installed. All these devices may support wired and/or wireless network or generally communication connections. For example, wired Ethernet or generally LAN (local area network) interface may be provided in some devices 104c, 104e whereas the remaining devices 104a, 104b, 104d, 104f may dominantly support at least cellular or wireless LAN connections.

The terminals 104a, 104b, 104c, 104d, 104e, 104f may be provided with observation and communication, or ‘metering’, logic 108 e.g. in the form of a computer (processing device) executable software application via a network connection or on a physical carrier medium such as a memory card or optical disc. The software may be optionally bundled with other software. The logic is configured to log data on terminal, application, service usage, etc. and other events taking place therein. The data may be transmitted e.g. in batches to the arrangement 114 for processing, analysis and/or storage in the light of desired media measurements. The transmissions may be timed, substantially immediate following the acquisition of the data, and/or be based on other predefined triggers.

In some embodiments, the obtained data may be subjected to analysis already at the terminals 104a, 104b, 104c, 104d, 104e, 104f. For example, a number of characteristic (representative) vectors may be determined therefrom. The vectors may be stored and transferred forward to the arrangement 114.

Preferably the observation and communication logic acts in the background so that any user actions are not necessary for its execution, and the logic may actually be completely transparent to the user (by default not visually indicated to the user, for example).

Yet in some embodiments, a number of external systems 116 may provide data to the arrangement 114. For example, third-party apps distributed by the systems 116 of third-party app developers may be arranged with metering software (observation logic) that collects measurement data useful to the panel study. The data may be provided from the apps to the arrangement 114 optionally via the developers' systems 116.

With reference to aforementioned categories, the panelists may have been classified into a plurality of categories depending on their compliance, which may refer to e.g. completeness of the data associated with them during a reporting period according to a selected logic.

The server arrangement 114 comprises or is at least functionally connected to a data repository 112, such as one or more databases accessible by the arrangement 114, configured to store data such as data regarding a plurality of panelists. For example, the obtained data may be initially stored in a plurality of data repositories or structures, e.g. one per panel(list) category, while following the data completion and optional further tasks such as validity related operations, a common data structure, or ‘panel’, may be established incorporating both the data of originally compliant/valid panelists and panelists with ascribed data points or e.g. virtual panelists depending on the embodiment.

The arrangement 114 is configured to complete the data when applicable and preferably determine different deliverables such as media usage reports based thereon to be distributed to a number of client systems 111. For the purpose, the arrangement 114 may comprise a number of different functional modules 113 such as classification, validation (this may comprise different validity analysis/filtering tasks at different stages of the panel data acquisition and cultivation process, e.g. activity validation to determine initial group of panelists having regard to a reporting period and subsequent validity analysis/quality assurance operations filtering the panelists based on their data reliability or probability), ascription and/or reporting modules.

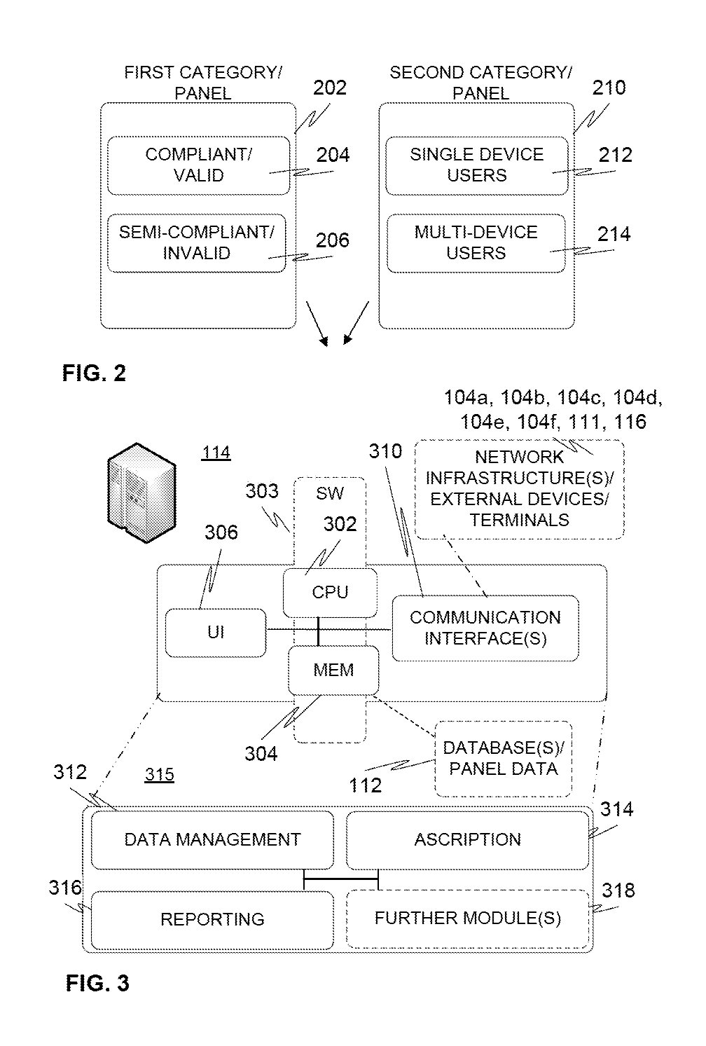

FIG. 2 depicts panelist categorization aspects of the present invention in accordance with few embodiments thereof. Simultaneously, the figure illustrates different sources (component panels and related groups/sub-panels) of overall, aggregate or ‘mega’ panel data, indicated by the converging arrows in the figure, which may be utilized in connection with the present invention for media measurements and other purposes. The integration level of different panels/data sources may be determined case specifically in each embodiment.

As mentioned hereinbefore, in various embodiments the panelists may be classified into a plurality of categories or depending on the implementation and viewpoint taken, initially several parallel panels of different types (categories) of panelists may be formed by classifying the obtained data having regard to the plurality of panelists. Preferably one panelist is allocated to one category/initial panel only.

First category or first panel 202 may generally relate to more rigorously-controlled panel of multi-device users (e.g. a calibration panel that may also be called as “smart panel” of smart panelists). This panel may be associated with and incorporate data regarding a number of compliant panelists 204 (e.g. panelists who have successfully maintained metering software/logic on their all declared meterable devices for a given time period and have passed potential other requirement(s)).

Additionally or alternatively, the first category 202 may comprise (data of) a plurality of semi-compliant/invalid panelists 206 (e.g. panelists who have successfully maintained the metering logic on one or more but not on their all declared meterable devices for a given time period). In some other embodiments, panelist groups 204, 206 could be considered to establish categories or panels of their own.

The semi-compliant/invalid members 206 of the smart panel 202 may include individuals who indeed have the metering logic installed to one or more of their devices but for one or more reasons were considered to be invalid in a given reporting period. This group of users may have one or more of the following characteristics:

a complete set of demographics (e.g. based on a digital or paper-based registration questionnaire) for each panelist in this category is known (by the arrangement), and a complete device inventory (e.g. from the questionnaire) for each panelist in this group is known (by the arrangement).

Profile data points such as behavioral profile data points may be calculated to such users by the arrangement on the basis of metered devices. Generally, the data of semi-compliant/invalid first category panelists 206 may be completed (attributed) according to the principles set forth herein.

However, in embodiments where rigorous control over the panelists is not applied or turns out practically impossible (not available due to technical reasons or the number of applicable panelists, for instance), the semi-compliant/invalid members 206 may establish substantially the whole first category of users 202.

A second category or second panel 210 may refer to a more uncontrolled panel of e.g. single-device 212 or multi-device 214 users (a so-called ‘boost panel’ or Thegapaner) potentially recruited on opt-in basis optionally through host software (application) with which the metering logic has been bundled with.

The second category 210 thus comprises panelists who have installed metering logic into one or more of their devices, and have preferably opted-in to participate in the panel (study). It may be the case that the host application developer and/or other entity has (or has not) shared (e.g. transferred as data signal(s)):

demographic profile data points of such panelists with the arrangement, and/or;
device inventory profile data points of such panelists with the arrangement, and/or;
qualitative profile data points (e.g. product consumption, brand awareness data, etc.) with the arrangement.

Single device boost panelists 212 may refer to panelists who have been recruited through a (third-party) app potentially in a completely uncontrolled fashion, but who have preferably opted-in to participate in the panel research.

Multi-device panelists 214 may refer to a group of panelists who have been recruited through the (third-party) app in a completely uncontrolled fashion, but who have opted-in to participate in the panel research, and who have installed the metering logic (software) to more than one device.

Again, profile data points such as behavioral profile data points may be calculated to the panelists of the second category by the arrangement. Generally, the data of the second category panelists may be completed (attributed) according to the principles set forth herein.

In addition to panels, e.g. a structural study regarding the demographics and/or other characteristics of device users in a target region such as country may have been executed for calibrating the data, for example.

With reference to FIG. 3, the arrangement 114 may be physically established by at least one electronic device, such as a server computer (apparatus/device). The system 114 may, however, in some embodiments comprise a plurality of at least functionally connected devices such as servers and optional further elements, e.g. gateways, proxies, data repositories, firewalls, etc. At least some of the included resources such as servers or computing/storage capacity providing equipment in general may be dynamically allocable from a cloud computing environment, for instance.

At least one processing unit 302 such as a microprocessor, microcontroller and/or a digital signal processor may be included. The processing unit 302 may be configured to execute instructions embodied in a form of computer software 303 stored in a memory 204, which may refer to one or more memory chips or generally memory units separate or integral with the processing unit 302 and/or other elements.

The software 303 may define e.g. one or more applications, routines, algorithms, etc. for panel data processing such as ascription and derivation of different output elements such as digital reports to clients 111. A computer program product comprising the appropriate software code means may be provided. It may be embodied in a non-transitory carrier medium such as a memory card, an optical disc or a USB (Universal Serial Bus) stick, for example. The program could be transferred as a signal or combination of signals wiredly or wirelessly from a transmitting element to a receiving element such as the arrangement 114.

One or more data repositories such as database(s) 112 of preferred structure and storing e.g. the obtained, completed and/or processed panel data may be established in the memory 304 for utilization by the processing unit 302. The repositories may physically incorporate e.g. RAM (random-access memory) memory, ROM (read-only memory), Flash) memory, magnetic/hard disc, optical disc, memory card, etc.

A UI (user interface) 306 may provide the necessary control and access tools for controlling the arrangement (e.g. definition of library management rules or data analysis logic) and/or accessing (visualizing, distributing) the data gathered and derived. The UI 306 may include local components for data input (e.g. keyboard, touchscreen, mouse, voice input) and output (display, audio output) and/or remote input and output optionally via a web interface, preferably web browser interface. The system may thus host or be at least functionally connected to a web server, for instance.

Accordingly, the depicted communication interface(s) 310 refer to one or more data interfaces such as wired network (e.g. Ethernet) and/or wireless network (e.g. wireless LAN (WLAN) or cellular) interfaces for interfacing a number of external devices and systems with the system of the present invention for data input and output purposes, potentially including control. The arrangement 114 may be connected to the Internet for globally enabling easy and widespread communication therewith. It is straightforward to contemplate by a skilled person that when an embodiment of the arrangement 114 comprises a plurality of functionally connected devices, any such device may contain a processing unit, memory, and e.g. communication interface of its own (for mutual and/or external communication).

When primarily considered from a functional or conceptual standpoint, see the lower block diagram at 315, the arrangement 114 may comprise a number of functional modules, which in this case refer to functional ensembles that could also be physically realized in a variety of other ways depending on the embodiments, e.g. either by larger ensembles covering a greater number of functionalities or by smaller ensembles concentrating on a fewer number of functionalities. The ensembles may contain program code or instructions and other data stored in the memory 304. The actual execution may be performed by the at least one processing unit 302.

Data management module 312 may be configured to generally manage data input such as acquisition/reception of panelist characterizing data, data output such as provision of established deliverables (e.g. reports on media usage) and/or data distribution between modules.

Ascription module 314 may be configured to complete data originally missing from the obtained data with reference to categories or groups of semi-compliant panelists or e.g. boost panelists having regard to which complete data has not been made duly available to the arrangement.

Reporting module 316 may be configured to determine a number of deliverables, or ‘reports’, to the clients 111. The deliverables may describe the usage of different devices, services, web pages, i.e. content and media and related user characteristics, for example.

Further module(s) 318 may include e.g. the aforesaid classification module, validation module, weighting or calibration module, etc.

The terminal devices and/or external devices/systems directly or indirectly connected to the arrangement 114 for providing data thereto or obtaining data such as deliverables therefrom, may generally contain similar hardware elements such as processor, memory and communication interface. Preferably, in particular the user devices in possession of panelists, such as various terminals, may be equipped with metering logic for gathering data on media usage of the panelist. The metering logic may be configured to log data on a number of potentially predefined events, occurrences, measurements and provide the log forward towards the arrangement either directly or via different host application systems when bundled with other software, for example.

Having regard to different embodiments of the modules of FIG. 3, a person skilled in the art will appreciate the fact that the above modules and associated functionalities may be realized in a number of ways. A module may indeed be divided to functionally even smaller units or two or more modules may be integrated to establish a larger functional entity. In case the arrangement 114 comprises several at least functionally connected devices, the modules may be executed by dedicated one or more devices or the execution may be shared, even with dynamic allocation, among multiple devices e.g. in a cloud computing environment.

In general, the attribution modeling (ascription) described herein to complete missing data may be based on methods of probabilistic characteristic prediction.

Panelists in a category or group may be described in terms of their metered behavior (e.g. traffic) across their devices, demographics, device inventory, qualitative characteristics (e.g. product consumption, brand awareness, etc.), and behavioral characteristics such as behavioral profile data points computed from metered behavior across metered devices.

Other panelists except fully compliant/valid smart panelists have missing values for certain of the characteristics or generally, data points. For example, traffic data may be missing for non-metered devices, behavioral characteristics may be missing for non-metered devices, demographics may be missing because the third-party app developer has not provided them, device inventory data may be missing because e.g. the third-party app developer has not provided it, and/or qualitative characteristics may be missing because e.g. the third-party app developer has not provided them.

Even those smart panel members who are considered compliant/valid may have some (allowed/tolerated) missing values e.g. for qualitative characteristics (e.g. product consumption data) since such data was not necessarily collected from smart panelists during or after registration.

Different characteristics/data points may be assigned a probability ranging from 0% (completely unlikely) to 100% (certain). Characteristics whose values are missing may be assumed to have a null (missing) probability. In contrast, any characteristic value that is supplied by the panelist or directly observed by the meter may be assumed to have a probability of 100%. Given this, e.g. traffic data really observed using the meter may be assumed to have 100% probability, behavioral characteristics determined based on metered traffic data may be assumed to have 100% probability, demographics provided by panelists e.g. in the registration survey/questionnaire or received from a third-party may be assumed to have 100% probability, device inventory provided in the registration survey or received from a third-party may be assumed to have 100% probability, and qualitative characteristics collected in the registration survey or e.g. received from a third-party may be assumed to have 100% probability.

For those panelists who have missing characteristic values, the values and their probabilities can be completed through estimation based on the data of similar other panelists who have such characteristic values preferably with a probability of 100% according to an embodiment of the ascription (attribution) procedure described herein.

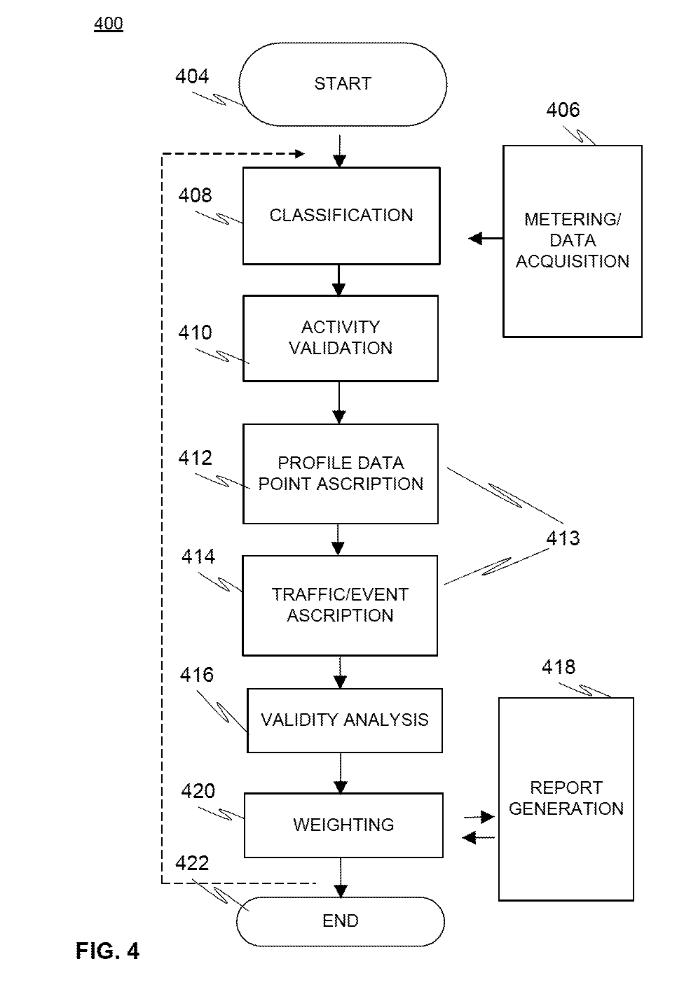

FIG. 4 is a flow diagram 400 disclosing an embodiment of a method in accordance with the present invention. Although the shown diagram contains a plurality of definite method items, in various other embodiments all the same items do not have to present. There may be additional method items as well that are not shown in the figure.

At method start-up 404, different preparatory tasks may be executed. For example, one or more structural studies may be executed, surveys/questionnaires performed and panelists recruited, metering software bundling with various host applications arranged, communication connections and links established and tested, etc. The arrangement may be set up and configured to receive or fetch, i.e. obtain, data for storage, processing and subsequent establishment of related deliverables such as reports.

At 406, data for the panels, such as demographic data, metered event/traffic data, etc. may be obtained optionally from a plurality of different sources, such as terminal devices, host (typically third party) application providers, study or questionnaire organizers, etc.

At 408, the obtained data may be classified into a plurality of categories as mentioned hereinbefore depending on their completeness and/or validity, for example.

At 410, activity validation, being already contemplated hereinbefore, may take place. In order to maintain the integrity of reported data, the panelists who are analyzed within the ascription process may be validated as to their activity for a reporting time period. This activity validation can either occur before profile data point ascription 412, or it can occur during the after ascription during e.g. validity analysis.

The argument for executing activity validation already before profile data point ascription is that it may significantly reduce the number of panelists for whom ascription is to be completed, thus significantly lowering the computational burden.

At 413, ascription procedure(s) such as profile data point ascription 412 and/or traffic/event data ascription 414 may take place.

There are various different options available for profile data point ascription.

For instance, a composite model may be adopted. It incorporates the creation of a “composite panelist” who combines the most probable characteristics and behavior given a set of actually known (100% certain) characteristics.

As another option, limited probabilistic model may be adopted. This option comprises creating virtual panelists based on their overall similarity to a panelist in question.

Considering first the composite model, a list of panelists (who passed activity validation 410) may be established. Then the list may be sorted in ascending order by the total number of profile data points (including behavioral profile data points) that have not been attributed (attributed=false) but metered or optionally determined otherwise as perfectly reliable.

Using the sequential list generated, next panelist in sequence may be selected for determining the set of values for missing profile data points (including behavioral profile data points).

For the panelist selected, the first profile data point that is missing a value may be determined. If no profile data point is missing a value, the panelist may be directly copied (along with all traffic data) to the result or ‘final’ panel (or corresponding data ensemble) that is processed further and used for determining the deliverables. A next panelist is selected for attribution.

Next, other panelists of the list that

a. have a value for the profile data point selected above with attributed=false, and;
b. whose profile data point values are equal to the profile data point values of the panelist selected for determining,
may be selected.

CHOICE: Should the list of panelists determined be empty, there are two options for how to proceed:

a. Leave the profile data point determined as missing, but:
i. set it to attributed=true
ii. with a probability of 100%, and;
iii. proceed with the next profile data point whose value is missing.
b. Return to above selection of panelists, but reduce the number of profile data points matched.

Should the above selection be by-passed because the list of panelists selected is not empty, then the frequency distribution of values for the profile data point determined amongst the panelists selected may be calculated.

NOTE: If option b (reduced number of matched data points) above is selected, then the frequency distribution should be weighted according to the proportion of profile data points that were used to establish the match in panelist selection (b).

Now, according to the composite model, from the frequency distribution calculated, the value with the greatest fraction may be selected. That value may be applied to the profile data point determined for the panelist under scrutiny with attribution=true and a probability equal to the fraction computed for that value.

Then, the execution may revert to proceeding with the next profile data point missing a value.

When the data points for that panelist have been addressed, the execution may proceed with the next panelist.

For each panelist in the list of panelists created and updated as applicable, their compound probability using the probabilities assigned to their profile data points may be calculated. This probability should be assigned to the panelist.

Instead of composite model, a so-called unlimited probabilistic model could be considered where for each value in the frequency distribution calculated a new virtual panelist was created where the value with greatest fraction is applied to the profile data point determined (the one missing a value) with attributed=true and probability equal to the fraction computed for that value. All other profile data points and event/traffic data could be copied from the single panelist under scrutiny. For each panelist with virtual=false the related virtual panelists with the highest number of profile data points with values may be selected. All other panelists could be deleted as “partially-completed work-in-progress”. However, the unlimited model is computationally exhaustive as being easily understood by a skilled person (exponential growth in the data volumes to be processed).

Therefore, a more practical, less exhaustive, limited probabilistic model could be applied instead.

Again, a list of panelists (who passed activity validation 410) may be established. Then the list may be sorted in ascending order by the total number of profile data points (including behavioral profile data points) that have not been attributed (attributed=false) but metered or optionally determined otherwise as perfectly reliable.

Using the sequential list generated, next panelist in sequence may be selected for analysis and determining the set of values for missing profile data points (including behavioral profile data points).

From the set of profile data point values determined above, those profile data points that are missing values may be then identified.

From the list of panelists those panelists who have the profile data points identified with attributed=false and which are not missing values may be selected.

For each panelist selected, a similarity index may be computed. There are varying ways of computing a similarity index but one relatively easy method involves counting the number of profile data points for each panelist selected which are equal to the corresponding profile data point for the panelist selected for the determination of missing data point values.

The list of panelists selected according to the similarity index computed may be sorted.

From the list of panelists sorted, the k most-similar panelists may be selected. k should be considered the limit that is applied to the “limited probabilistic model”. k may be a suitable positive integer (preferably larger than 1, of course).

For each panelist selected above (k similar panelists), a virtual panelist may be created where

a. Profile data points with attributed=false are copied from the panelist selected for analysis (“next”).
b. Traffic data is copied from the panelist selected.
c. Profile data points identified as missing data values are copied from the panelist selected from the group of similar panelists (“each panelist”) with attributed=true and a probability of 1/k.
d. Traffic data for devices identified as missing data values is copied from the panelist selected from the group of similar panelists (“each panelist”) with attributed=true and a probability of 1/k, and
e. A compound probability is assigned to the panelist of 1/k.

The next panelist may be then selected and the above procedure repeated.

At 414, traffic/event data ascription is executed. The following embodiment is constructed from the standpoint of the composite model described above.

Few assumptions could be taken first: a panelist's missing device inventory will be ascribed as just another profile data point in the profile data point ascription process described above. Given the meter data held for each panelist, the panelist's device inventory profile data points can be used to determine which panelist devices are not metered. Behavioral profile data points for non-metered devices will be ascribed within the profile data point ascription process. Given the behavioral profile data points for non-metered devices, it should be possible to ascribe traffic data to those non-metered devices. Events tied to panelist devices with metered=true must have attributed=false and a probability of 100%. The traffic ascription process will run according to the data publication or reporting cycle, e.g. every 24 h and will encompass a given 24-hour time period.

Having regard to the actual process, a (first) list of all panelists may be created, from different categories or panels (e.g. smart and boost), who have one or more device inventory profile data points with attributed=true. In other words, at least one such data point has been calculated/estimated instead of metering or based on other certain knowledge.

Also a (second) list of all panelists may be established.

The first panelist from the first list may be then selected for data completion.

For the panelist selected, the first device Inventory profile data point with attributed=true may be selected.

For the device inventory profile data point selected, it may be checked whether a corresponding panelist device exists for the panelist.

a. If yes, the execution may proceed directly to the “Continuation point” below.
b. If no:
i. from the list of all panelists (including e.g. smart and boost categories/panelists) those panelists who have a corresponding device inventory profile data point as selected but with attributed=false are selected.
ii. A frequency distribution for each device type and device model given from the panelists selected in (i) is generated.
iii. The device type/model (device_id, describing panelist device) with the highest fraction from the frequency distribution computed in (bii) is selected.
iv. For the panelist selected, create a corresponding panelist device with:
1. metered=false, and;
2. attributed=true, and;
3. a device_id that matches the value determined in (biii).
   v. proceed to “Continuation point”.

Continuation point: For the panelist selected, a list of all behavioral profile data points with attributed=true that is associated with the device indicated by the panelist device checked/created above is to be generated.

From the list of all panelists, all panelists who have a panelist device with attributed=false and metered=true which relates to the same device as the Panelist Device checked/created above may be now selected.

For the panelists just selected, a list of all behavioral profile data points that:

a. are associated with the device that matches the panelist device checked/created above, and;
b. have a binary value indicating usage or ownership, as applicable.
may be extracted.

For the first hour in the processing time period:

a. For each behavioral profile data point in the list generated above, it is preferred to determine the number of each event:
i. generated on the subject associated with that behavioral profile data point using a panelist device whose device matches that checked/created above by the panelists selected above.
   1. whose behavioral profile data points match those of the panelist selected for data completion, and;
   a1. which occurred in the hour selected above.
      b. Divide the number of each event type computed above in (a) by the number of panelists in the filtered list derived above (in items ai1a1).
      c. For event types that have duration (i.e. a start time and end time), compute the average duration of the events just computed in (a) above.

For the panelist selected for data completion, new events may be created that:

a. are associated with the panelist device checked/created above, and;
b. occur inside the hour selected above, and;
c. have a duration (start time and end time) equal to the average duration computed above in (c), and;
d. have a probability computed to maintain a consistent value of average events per panelist as just computed in (b) above.

Then the execution may proceed to the next hour and be repeated until all hours in the processing time period have been processed.

At 416, an embodiment of validity analysis may take place.

Once the ascription model has been applied, the next preferred activity is to perform QA (quality analysis) on the resulting data. The QA process may be used to determine which panelists/virtual panelists are ultimately included in the reporting dataset. There are e.g. three factors that can be used to exclude panelists from the reporting dataset:
Their compound probability. Thus, panelists whose compound probability is below a certain selected factor p would by definition be excluded.
The profile data points attributed. There may be certain profile data points which—by definition—shall not have attributed=true. If these “most important” data points are attributed, then the panelist would be excluded.
Attributed profile data points have probabilities that are too low. There may be profile data points whose probability is too low to be considered acceptable. For example, even if gender is allowed to be attributed, a gender with a probability of 1% may be considered too low to be included in the reporting dataset.

The set of rules that govern this validity analysis may be adjusted on a geographic basis, with different rules determined based on the combination and quality of different categories/panels in that marketplace.

Item 420 refers to weighting/calibration tasks. The sample subjected to calibration may contain all those panelists and virtual panelists who passed the validity analysis described above. Calibration may occur e.g. on a country-by-country basis, utilizing survey and other behavioral data as calibration targets, for instance.

Item 418 refers to the generation of desired deliverables/reports that the users (clients) of the arrangement are keen on receiving. The deliverables may include a number of metrics and/or statistics derived based on the obtained and processed data having regard to a desired time span, for example. Media audience itself may be described as well as their media consumption and/or other habits, preferences, dislikes, etc.

The deliverables may be in predefined proprietary or more commonly used digital format enabling a recipient to adjust its functions or operations including service or content personalization and e.g. (technical) system optimization (bandwidth, etc.) optionally automatically based thereon according to the used logic.

At 422, the method execution is ended.

The dotted, only exemplary, loop-back arrow reflects the likely repetitive nature of various method items when executed in different real-life and potentially also substantially real-time scenarios wherein new data becomes repeatedly if not continuously available and it may be then processed e.g. in batches for covering a related desired reporting period with target deliverables including various statistics, etc.

The scope is defined by the attached independent claims with appropriate national extensions thereof having regard to the applicability of the doctrine of equivalents.

1. A method for enhancing data integrity in connection with a digital panel study to be performed by an electronic arrangement preferably comprising one or more servers, wherein the method comprises
obtaining data having regard to a plurality of panelists, wherein one or more data points associated with each panelist characterize demographic profile, device ownership, device-level behavioral profile and/or occurrences of events or traffic involving one or more electronic devices associated with the panelist, and where there is more and less complete data associated with different panelists in terms of data points,
for a certain panelist of said plurality missing a data point, determining, based on the obtained data, a number of other panelists that originally have corresponding data point assigned and are otherwise similar to the certain panelist in terms of a number of other data points according to a selected criterion, preferably requiring similar data point values, and
completing the missing data point of the certain panelist, or modeling a virtual panelist having data points assigned similar to the other data points and a further data point, based on data of the corresponding data point of one or more of the determined other panelists.

2. The method of claim 1, comprising classifying the obtained data into at least two categories, wherein the first category is associated with a more controlled group of panelists with more complete data and the second category is associated with a less controlled group of panelists with less complete or otherwise uncompliant data.

3. The method of claim 1, comprising classifying the obtained data into at least two categories, wherein the first category is associated with a more controlled group of panelists with more complete data and the second category is associated with a less controlled group of panelists with less complete or otherwise uncompliant data, wherein the other panelists are determined solely from the first category, most preferably solely based on the data of fully compliant and valid panelists of the first category.

4. The method of claim 1, wherein the data points include panelist profile data points preferably indicative of at least one element selected from the group consisting of: demographic profile, device inventory profile, qualitative profile, and behavioral profile of the concerned panelist.

5. The method of claim 1, wherein the data points include data points indicative of traffic or events involving one or more electronic devices associated with a panelist.

6. The method of claim 1, wherein having regard to a panelist under scrutiny a composite model is established, wherein data indicative of known characteristics, preferably metered characteristics, and data indicative of probable characteristics obtained by the completion are combined into a common model.

7. The method of claim 1, wherein a number of virtual panelists are established based on the existing data of a panelist under scrutiny and data representing the originally missing data point of a corresponding number of other panelists considered most similar to the panelist in question.

8. The method of claim 1, wherein the obtained data is subjected to activity validation for determining panelists the data of which should be utilized, preferably for completion tasks, during a predetermined time period, optionally a reporting time period, wherein the data of panelists considered active during said time period or other past time span is utilized whereas the data of panelists considered passive during the same is omitted.

9. The method of claim 1, wherein to determine panelists the data of which is utilized in a reporting dataset, validity analysis is executed with a number of selected criteria.

10. The method of claim 1, wherein to determine panelists the data of which is utilized in a reporting dataset, validity analysis is executed with a number of selected criteria, and wherein the criteria may be based on at least one element selected from the group consisting of: probability of data validity, presence of completed data in a data point considered critical, and presence of at least one completed data point with probability below or above a predefined threshold.

11. The method of claim 1, comprising weighting or calibration of panelist data, optionally based on a preliminary study characterizing the population researched including at least portion of, preferably all, the panelists of said plurality.

12. The method of claim 1, comprising determination of a digital deliverable, optionally report, statistics and/or metrics, with a predefined scope based on the data obtained and completed.

13. An electronic arrangement, preferably comprising a number of at least functionally connected servers, for enhancing data integrity in connection with a digital panel study, the arrangement comprising
data management module configured to obtain data having regard to a plurality of panelists, wherein one or more data points associated with each panelist characterize the panelist's demographic profile, device ownership profile, device-level behavioral profile and/or occurrences of events or traffic involving one or more electronic devices associated with the panelist, and where there is more and less complete data associated with different panelists in terms of data points, and
ascription module configured to determine, for a certain panelist of said plurality missing a data point, based on the obtained data, a number of other panelists that originally have corresponding data point assigned and are otherwise similar to the certain panelist in terms of a number of other data points according to a selected criterion, preferably requiring similar data point values, and to
complete the missing data point of the certain panelist, or modeling a virtual panelist having data points assigned similar to the other data points and a further data point, based on data of the corresponding data point of one or more of the determined other panelists.

14. The arrangement of claim 13, further comprising at least one element selected from the group consisting of: reporting module configured to establish a digital deliverable based on the ascribed data and characterizing the data preferably through a number of statistics and/or metrics, calibration module configured to weight panelist data according to a predefined weighting scheme, and validation module configured to validate panelist data based on the detected activity of the panelist and/or probability of the data.

15. A computer program product embodied in a non-transitory carrier medium comprising code means adapted, when executed on a computer, to perform the steps of
obtaining data having regard to a plurality of panelists, wherein one or more data points associated with each panelist characterize demographic profile, device ownership, device-level behavioral profile and/or occurrences of events or traffic involving one or more electronic devices associated with the panelist, and where there is more and less complete data associated with different panelists in terms of data points,
for a certain panelist of said plurality missing a data point, determining, based on the obtained data, a number of other panelists that originally have corresponding data point assigned and are otherwise similar to the certain panelist in terms of a number of other data points according to a selected criterion, preferably requiring similar data point values, and
completing the missing data point of the certain panelist, or modeling a virtual panelist having data points assigned similar to the other data points and a further data point, based on data of the corresponding data point of one or more of the determined other panelists.

16. (canceled)
